(19) United States
(12) Patent Application Publication
(10) Pub. No.: US 2025/0103742 A1
(43) Pub. Date: Mar. 27, 2025

(54) DATA SECURITY MANAGEMENT CONTROL SYSTEM AND METHOD

(71) Applicant: HANGZHOU LAIBU TECHNOLOGY CO., LTD., Hangzhou (CN)

(72) Inventors: Xiaojing Ma, Hangzhou (CN); Yanhua Li, Hangzhou (CN); Fengchun Yang, Hangzhou (CN); Zhixiao Yang, Hangzhou (CN); Xiaojun Zhu, Hangzhou (CN)

(21) Appl. No.: 18/890,719

(22) Filed: Sep. 19, 2024

(30) Foreign Application Priority Data
Sep. 22, 2023 (CN) 202311231125.0

(51) Int. Cl. G06F 21/62

(52) U.S. Cl. CPC G06F 21/6218

(57) ABSTRACT

The invention relates to a data security management control system and a data security management control method. The system comprises at least two user terminals which are provided with file management systems, wherein the file management system of one user terminal receives file management information corresponding to an original file and encapsulates the original file and the file management information into a composite file according to a preset file format; The file management system of at least one other user terminal reads the file management information in the composite file and uses the original file according to the file management information. According to the invention, the file management information is integrated into the file, so that the file can be controlled at any time in the flowing process, and the data security management capability is improved.

### CROSS REFERENCE TO RELATED APPLICATIONS

The present application claims the benefit of Chinese Patent Application No. 202311231125.0 filed on Sep. 22, 2023, the contents of which are incorporated herein by reference in their entirety.

### TECHNICAL FIELD

The invention relates to the field of data security management, in particular to a data security management control system and a data security management control method.

### DESCRIPTION OF RELATED ART

Data security and data management are very important in the information age. In the field of data security, Network Isolation and authorized user authentication is often used in the existing technology, such as firewall, virtual machine environment and so on.

The advantage of using firewall is that the security protection of illegal users is insensitive, but the disadvantage of this method is that once the data is transmitted to the authorized user, the user will operate the data at will, for example, the data can be copied again, and changed into their own data or directly spread the copied data, resulting in some important data is easy to leak.

The advantage of use a virtual machine environment is that the user access to data is isolated, but the disadvantage of the method is that the user needs to install a corresponding desktop environment, and the data need to be transmitted to the cloud, and if the cloud is attacked, the data can also be leaked.

Therefore, in the prior art, the data security management relies on external equipment, and the management is not in place when the authorized user uses the data, and there are also data security risks.

### BRIEF SUMMARY OF THE INVENTION

The technical problem to be solved by the invention is to provide a data security management control system and a data security management control method.

The technical solution adopted by the present invention to solve its technical problem is to construct a data security management control system, The data security management control system comprises at least two user terminals, wherein each user terminal is provided with a file management system;

The file management system of one of the user terminals receives file management information corresponding to an original file, and encapsulates the original file and the file management information into a composite file according to a preset file format;

The file management system of at least one of the other user terminals reads the file management information in the composite file, and uses the original file according to the file management information.

Further, in the data security management control system of the present invention, the file management system of the user terminal stores the file management information in the composite file in the form of a file header;

The file management system of the user terminal obtains the file management information by reading the file header of the composite file.

Further, in the data security management control system of the present invention, the file header of the composite file comprises an information identification bit corresponding to the file management information;

The file management system of the user terminal identifies the information identification bit in the composite file, and reads the file management information corresponding to the information identification bit.

Furthermore, in the data security management control system of the present invention, the file management information is file use permission information, and the file management system of the user terminal uses the original file within a permission range corresponding to the file use permission information.

Further, in the data security management control system of the present invention, the system further comprises a server, wherein the server is in communication connection with each of the user terminals;

The server is configured to manage the user account corresponding to the file management system, the file management information, and the composite file.

In addition, the invention also provides a data security management control method, which comprises the following steps:
Receiving file management information corresponding to an original file;
Encapsulating the original file and the file management information into a composite file according to a preset file format;
Reading the file management information in the composite file;
And using the original file according to the file management information.

Further, in the data security management control method of the present invention, the encapsulating the original file and the file management information into a composite file according to a preset file format comprises:

Converting the file management information into a file header, and converting the file header and the original file into the composite file according to a preset file format, wherein the file header comprises an information identification bit corresponding to the file management information.

Further, in the data security management control method of the present invention, the reading the file management information in the composite file comprises:

Identifying an information identification bit in the composite file, and reading the file management information corresponding to the information identification bit.

Further, in the data security management control method of the present invention, the file management information is file use permission information, and using the original file according to the file management information comprises:

Using the original file within a permission range corresponding to the file use permission information.

Further, in the data security management control method of the present invention, the file use permission information comprises at least one of a file viewing permission, a file editing permission, a file deleting permission, a file destroying permission, a file authorization permission, and a file copying permission.

The data security management control system and the data security management control method have the following beneficial effects that the file management information is integrated into the file, so that the file is managed and controlled at any time in the flowing process, and the data security management capability is improved.

### BRIEF DESCRIPTION OF THE SEVERAL VIEWS OF THE DRAWINGS

The present invention will be further described with reference to the accompanying drawings and embodiments, in which:

FIG. 1 is a schematic diagram of a data security management control system according to an embodiment of the present invention;

FIG. 2 is a schematic diagram of a data security management control system according to an embodiment of the present invention;

FIG. 3 is a flowchart of a data security management control method according to an embodiment of the present invention.

### DETAILED DESCRIPTION OF THE INVENTION

For a clearer understanding of the technical features, objects, and effects of the present invention, specific embodiments of the present invention will now be described in detail with reference to the accompanying drawings.

In a preferred embodiment, the data security management control system of this embodiment comprises at least two user terminals, each user terminals are installed with a file management system, and the file management system is used to manage a composite file. It should be noted that the file management system in this embodiment is a part of the operating system used by the user terminal, that is, the file management system is a part of the kernel of the operating system, so that the file management system and the operating system run in the same space. Alternatively, the user terminal includes but is not limited to a desktop computer, a notebook computer, a tablet computer, a smart phone, a smart watch, a vehicle-mounted terminal, etc., and the operating system used by the user terminal includes but is not limited to a Windows operating system, a Mac OS operating system, a Linux operating system, an Android system, a HarmonyOS system, etc.

The data security management control system comprises at least two user terminals, wherein a file management system of one user terminal receives file management information corresponding to an original file, and the file management information refers to various information for managing the original file and can be set by a user according to management requirements. It can be understood that personalized file management information can be set for each original file. Further, one of the user terminals encapsulates the original file and the file management information into a composite file according to a preset file format. It should be noted that the composite file is an integral file, and the original file and the file management information have become an organic whole. Because the original file and the file management information have become an organic whole, the file management information flows with the composite file, so that the file itself carries the management information and can be managed at any time in the process of file flow.

One of the user terminals transfers the generated composite file to at least one other user terminal in the data security management control system, the transfer mode includes but is not limited to mail transmission, instant messaging tool transmission, cloud disk transmission, U disk transmission, optical disk transmission and the like, and the user can select the transfer mode as required. However, it should be understood that regardless of the transmission means used, the file management information will always be transferred synchronously with the composite file, thus realizing the self-management of the file at anytime and anywhere.

Further, after receiving the composite file, a file management system of at least one other user terminal in the data security management control system reads the file management information in the composite file according to a preset reading mode, and then uses the original file according to the file management information. The preset reading mode is set in the file management system, and other software cannot obtain the file management information in the composite file, so that one-layer security protection is realized through the file management system.

It can be understood that the above process describes that only one user terminal generates the composite file and other user terminals use the composite file, but it does not mean that the user terminal that generates the composite file only has the function of generating the composite file. In fact, the file management system on each user terminal has the functions of generating a composite file and using a composite file. The function of generating a composite file refers to packaging the original file and the file management information corresponding to the original file into a composite file according to a preset file format, and the function of using the composite file refers to obtaining the file management information in the composite file and managing the original file according to the file management information. That is, each user terminal is both a producer and a user of the composite file.

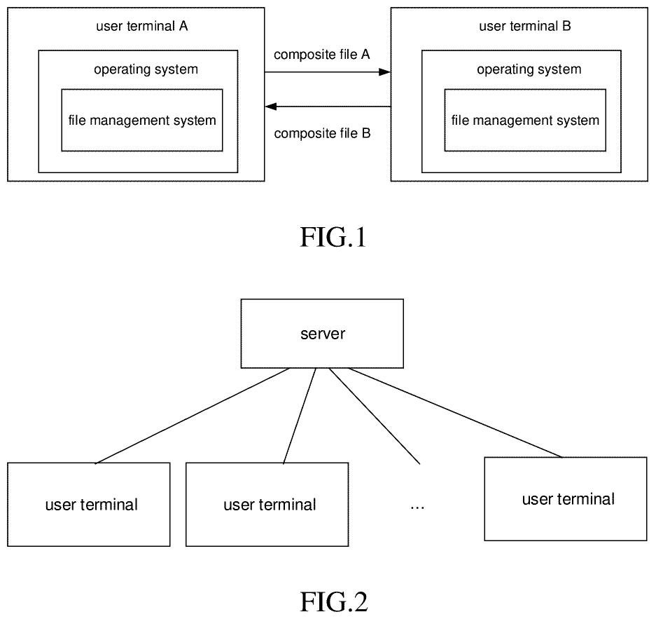

Referring to FIG. 1, the data security management control system in this embodiment includes two user terminals for explanation in principle, and other multiple user terminals can be referred to for implementation. The data security management control system comprises a user terminal A and a user terminal B, wherein both the user terminal A and the user terminal B have the functions of generating a composite file and using a composite file.

The user terminal A receives the file management information A corresponding to the original file A, and encapsulates the original file A and the file management information A into a composite file A according to a preset file format. Further, the generated composite file A is transferred to the user terminal B, and the user terminal B reads the file management information A in the composite file A, and then uses the original file A according to the file management information A. The transfer method is not limited to the transfer method, and the user terminal B reads the file management information A in the composite file A, and the user terminal B uses the original file A in accordance with the file management information A.

Similarly, the user terminal B receives the file management information B corresponding to the original file B, and encapsulates the original file B and the file management information B into a composite file B according to the preset file format. Further, the generated composite file B is migrated to the user terminal A, but the migration method is not limited, and the user terminal A reads the file management information B in the composite file B, and further uses the original file B according to the file management information B.

In addition, when the user terminal uses the composite file, the user terminal must first read the file management information in the composite file, and then use the original file according to the user management information. That is, the user terminal cannot directly read the original file in the composite file when using the composite file, because the file management information may include that the current user does not have the permission to open the file.

In this embodiment, the file management system of the user terminal and the composite file form a new file management system, and the main technical idea of the system is to incorporate the file management information into the file itself, so that the file can be controlled at any time in the flow process. In this way, no matter where the file flows, because it carries the file management information, it can realize the file self-management at anytime and anywhere, which greatly improves the data security management ability.

In the data security management control system of some embodiments, the file management information is used as the file header of the composite file, so that the file management system of the user terminal stores the file management information in the composite file in the form of the file header at the generation stage of the composite file. In the use stage of the composite file, the file management system of the user terminal obtains the file management information by reading the file header of the composite file.

Referring to FIG. 1, for example, the user terminal A stores the file management information A in the composite file A in the form of a file header, and when the composite file A is transferred to the user terminal B, the file management system of the user terminal B obtains the file management information A by reading the file header of the composite file A.

In this embodiment, the file management information is stored in the form of a file header, and each user terminal stores and reads the file management information in the composite file according to the same standard, so as to realize the standardization of the file management information in the composite file.

In the data security management control system of some embodiments, in order to further facilitate the user terminal to read the file management information in the composite file, the file management systems on all user terminals may uniformly agree that the file header of the composite file includes an information identification bit corresponding to the file management information, where the information identification bit is used to identify the location of the file management information in the composite file. Correspondingly, in the using stage of the composite file, the file management system of the user terminal first identifies the information identification bit in the composite file, and then reads the file management information corresponding to the information identification bit.

Alternatively, if the file management information includes a plurality of types of management information, a corresponding information identification bit may be set for each type of management information. Correspondingly, in the stage of using the composite file, the file management system of the user terminal identifies the information identification bit corresponding to certain management information as required, and then reads the management information. In this way, the file management information can be read more accurately, and only part of the file management information required is read each time, so that the reading speed is improved.

In this embodiment, the file management information is located by setting the information identification bit in the composite file, so that the location speed and accuracy of the file management information are improved, thereby accelerating the recognition and reading speed of the composite file.

In the data security management control system of some embodiments, the file management information is file use permission information, the file use permission information is used to limit the permission range of the user to use the original file, and the file management system of the user terminal uses the original file in the permission range corresponding to the file use permission information.

The file use permission information is various, and the user can set various file use permission information according to requirements. Alternatively, the file use permission information includes, but is not limited to, a file view permission, a file edit permission, a file delete permission, a file destroy permission, a file authorization permission, a file copy permission, etc.

The composite file in this embodiment includes the file use permission information and the original file, and the composite file can use the permission information to manage the original file at any time during the file flow process, so as to realize the permission management of the original file.

In the data security management control system of some embodiments, referring to FIG. 2, the data security management control system further comprises a server, and the server is communicatively connected with each user terminal. The server is configured to manage the user account, the file management information, and the composite file corresponding to the file management system.

A user account is stored on the server, and when the user uses the file management system on the user terminal, the user needs to log in the server on the file management system. The user terminal can also upload the composite file to the server for management.

The data security management control system of this embodiment further adds a server to synchronize more management information and improve the data management capability.

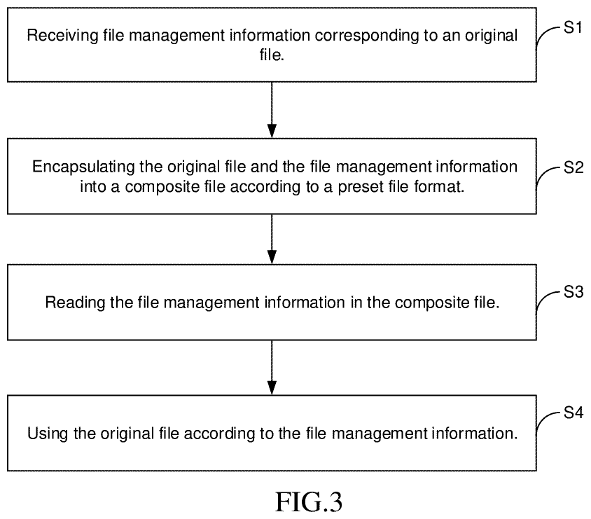

In a preferred embodiment, referring to FIG. 3, the data security management control method of this embodiment is applied to the data security management control system of the above embodiment, and the data security management control system refers to the above embodiment. Specifically, the data security management control method comprises the following steps:
S1, receiving file management information corresponding to an original file.

Specifically, the data security management control system comprises at least two user terminals, wherein a file management system of one of the user terminals receives file management information corresponding to the original file, and the file management information refers to various information for managing the original file and can be set as required.
S2, encapsulating the original file and the file management information into a composite file according to a preset file format.

Specifically, one of the user terminals encapsulates the original file and the file management information into a composite file according to a preset file format, the composite file is an integral file, and the original file and the file management information have become an organic whole. Because the original file and the file management information have become an organic whole, the file management information flows with the composite file, so that the file itself carries the management information and can be managed at any time in the process of file flow.
S3, reading the file management information in the composite file.

Specifically, one of the user terminals transfers the generated composite file to at least one of the other user terminals in the data security management control system, and a file management system of the at least one of the other user terminals in the data security management control system reads the file management information in the composite file according to a preset reading mode after receiving the composite file.

And S4, using the original file according to the file management information.

Specifically, the file management system of the at least one other user terminal uses the original file according to the file management information after reading the file management information in the composite file according to the preset reading mode.

In this embodiment, the file management information is integrated into the file itself, so that the file can be controlled at any time in the flow process, and the data security management capability is improved.

In the data security management control method of some embodiments, encapsulating the original file and the file management information into a composite file according to the preset file format comprises: converting the file management information into a file header, and converting the file header and the original file into the composite file according to the preset file format, wherein the file header comprises an information identification bit corresponding to the file management information. That is, the file management information is used as the header of the composite file, so that the file management system of the user terminal stores the file management information in the composite file in the form of the header at the composite file generation stage. In the use stage of the composite file, the file management system of the user terminal obtains the file management information by reading the file header of the composite file. In this embodiment, the file management information is stored in the form of a file header, and each user terminal stores and reads the file management information in the composite file according to the same standard, so as to realize the standardization of the file management information in the composite file.

In the data security management control method of some embodiments, reading the file management information in the composite file includes identifying an information identification bit in the composite file, and reading the file management information corresponding to the information identification bit.

Specifically, in order to further facilitate the user terminal to read the file management information in the composite file, the file management systems on all user terminals may uniformly agree that the file header of the composite file includes an information identification bit corresponding to the file management information, where the information identification bit is used to identify the location of the file management information in the composite file. Correspondingly, in the using stage of the composite file, the file management system of the user terminal first identifies the information identification bit in the composite file, and then reads the file management information corresponding to the information identification bit.

Alternatively, if the file management information includes a plurality of types of management information, a corresponding information identification bit may be set for each type of management information. Correspondingly, in the stage of using the composite file, the file management system of the user terminal identifies the information identification bit corresponding to certain management information as required, and then reads the management information. In this way, the file management information can be read more accurately, and only part of the file management information required is read each time, so that the reading speed is improved.

In this embodiment, the file management information is located by setting the information identification bit in the composite file, so that the location speed and accuracy of the file management information are improved, thereby accelerating the recognition and reading speed of the composite file.

In the data security management control method of some embodiments, the file management information is file use permission information, and using the original file according to the file management information includes using the original file according to the permission range corresponding to the file use permission information. The file use permission information is used for limiting the permission range of the user to use the original file, the file use permission information is various, and the user can set various file use permission information according to requirements. Alternatively, the file use permission information includes, but is not limited to, a file view permission, a file edit permission, a file delete permission, a file destroy permission, a file authorization permission, a file copy permission, etc.

The composite file in this embodiment includes the file use permission information and the original file, and the composite file can use the permission information to manage the original file at any time during the file flow process, so as to realize the permission management of the original file.

In this specification, each embodiment is described in a progressive manner, and each embodiment focuses on the differences from other embodiments, and the same and similar parts of each embodiment can be referred to each other. For the device disclosed in the embodiment, since it corresponds to the method disclosed in the embodiment, the description is relatively simple, and the related parts can be described in the method part.

Those skilled in the art will further appreciate that the elements and algorithm steps of the various examples described in connection with the embodiments disclosed herein can be implemented as electronic hardware, computer software, or a combination of both, hi the foregoing description, the components and steps of the various examples have been generally described in terms of function for the purpose of clearly illustrating the interchangeability of hardware and software. Whether these functions are implemented in hardware or software depends on the specific application and design constraints of the technical solution. Skilled artisans may implement the described functionality using different methods for each particular application, but such implementations should not be construed to exceed the scope of the invention.

The steps of a method or algorithm described in connection with the embodiments disclosed herein may be embodied directly in hardware, in a software module executed by a processor, or in a combination of the two. The software module may be placed in a random access memory (RAM), a memory, a read only memory (ROM), an electrically programmable ROM, an electrically erasable programmable ROM, a register, a hard disk, a removable disk, a CD-ROM, or any other form of storage medium known in the art.

The above embodiments are only for illustrating the technical concepts and features of the present invention, and are intended to enable those skilled in the art to understand the contents of the present invention and implement the same, and do not limit the scope of protection of the present invention. All equivalent change and modifications accord to that scope of the appended claims are intended to be cover by the appended claims.

What is claimed is:

1. A data security management control system, comprising at least two user terminals, wherein the user terminals are installed with a file management system;
the file management system of one of the user terminals receives file management information corresponding to an original file, and encapsulates the original file and the file management information into a composite file according to a preset file format;
the file management system of at least one of the other user terminals reads the file management information in the composite file, and uses the original file according to the file management information.

2. The data security management control system according to claim 1, wherein the file management system of the user terminal stores the file management information in the composite file in the form of a file header;
the file management system of the user terminal obtains the file management information by reading the file header of the composite file.

3. The data security management control system according to claim 2, wherein the file header of the composite file comprises an information identification bit corresponding to file management information;
the file management system of the user terminal identifies the information identification bit in the composite file, and reads the file management information corresponding to the information identification bit.

4. The data security management control system according to claim 1, wherein the file management information is file use permission information, and the file management system of the user terminal uses the original file within a permission range corresponding to the file use permission information.

5. The data security management control system according to claim 1, wherein the system further comprises a server and the server is communicatively connected to each of the user terminals;
the server is configured to manage the user account corresponding to the file management system, the file management information, and the composite file.

6. A data security management control method, comprising:
receiving file management information corresponding to an original file;
encapsulating the original file and the file management information into a composite file according to a preset file format;
reading the file management information in the composite file;
and using the original file according to the file management information.

7. The data security management control method according to claim 6, wherein the encapsulating the original file and the file management information into a composite file according to a preset file format comprises:
converting the file management information into a file header, and converting the file header and the original file into the composite file according to a preset file format, wherein the file header comprises an information identification bit corresponding to the file management information.

8. The data security management control method according to claim 7, wherein the reading the file management information in the composite file comprises:
identifying an information identification bit in the composite file, and read the file management information corresponding to the information identification bit.

9. The data security management control method according to claim 6, wherein the file management information is file use permission information, and using the original file according to the file management information comprises:
using the original file within a permission range corresponding to the file use permission information.

10. The data security management control method according to claim 9, wherein the file using permission information comprises at least one of a file viewing permission, a file editing permission, a file deleting permission, a file destroying permission, a file authorizing permission, and a file copying permission.
